(19) United States
(12) Patent Application Publication
(10) Pub. No.: US 2003/0026422 A1
(43) Pub. Date: Feb. 6, 2003

(54) Method and apparatus for digitally fingerprinting videos

(75) Inventors: Albert P. Gerheim, Westerly, RI (US); Paul A. Brandon, Stonington, CT (US)

Correspondence Address: ALIX YALE & RISTAS LLP, 750 MAIN STREET, SUITE 1400, HARTFORD, CT, 06103, US

(73) Assignee: USA Video Interactive Corporation

(21) Appl. No.: 09/884,787

(22) Filed: Jun. 19, 2001

(51) Int. Cl. H04N 7/167

(52) U.S. Cl. 380/210

(57) ABSTRACT

A method of fingerprinting digital video by inserting a watermark into individual color channels or the intensity channel of a streaming video. The watermark is a cryptographically encoded identifier for an authorized video delivery consisting of spectral lines inserted in the perceptually significant portions of the Fourier spectrum of the individual frames of the video. In-phase and quadrature components or sinusoids may be encoded in two chroma channels to provide shift-invariant detection of the spectral lines. The pattern is repeated for a perceptually significant duration to defeat frame-swapping attacks. The watermark is extracted by comparing a suspected pirated video to the original video. The watermark data is interpreted to identify the source of the pirated video to enable criminal prosecution.

### FIELD OF THE INVENTION

The present invention concerns an apparatus and method of fingerprinting digital video data for the purpose of identifying the history of any unauthorized copy of the video found at any stage of transmission or storage. The history thus revealed is intended to facilitate criminal prosecution or other punishment of responsible parties. The practice of fingerprinting, coupled with the publication of its forensic properties, is intended to deter unauthorized duplication and distribution of the video property. Specifically, a watermark is inserted into perceptually significant components of the data in a manner so as to be virtually imperceptible. More specifically, a narrow band signal representing the watermark is placed in a wideband channel that is the data. The method is not data-adaptive, and thus can be implemented in real time simultaneously with the authorized video distribution event.

### BACKGROUND OF THE INVENTION

The proliferation of digitized video has created a need for a security system that affords protection of this content. While such security systems do not prevent unauthorized duplications of video property, they deter such piracy by preserving in these unauthorized copies unique encrypted identifiers associated with the original authorized video delivery, allowing pirated copies to be traced back to the original source.

For purposes of this application, an authorized video stream is defined as a viewing event in which the owned content is first watched by an authorized viewer, either as a video stream sent from a server to a media player on the user's computer (or other viewing device) or through decoding and viewing a stored video file on this viewing device. Suspect video is defined as a copy of the original video suspected of being pirated or duplicated without permission, regardless of the method or number of duplications and analog-digital/digital-analog conversions.

An authorized video stream is subject to duplication via hacking, or, if nothing else, videotaping from the CRT on which it is displayed. To be protected, the content must be marked in a manner that uniquely identifies this stream. The fingerprinting apparatus and method discussed herein is a type of watermark applied to individual frames of the video content. To successfully deter piracy, the watermark should have the following attributes:

1. The watermark should be perceptually invisible or its presence should not interfere with the material being protected.

2. The watermark should be difficult and preferably virtually impossible to remove from the material without rendering the material useless for its intended purpose. Attempts to remove or destroy the watermark should render the data useless before the watermark is effectively removed.

3. The watermark should not be destroyed or lost if copies of the same data set are combined, precluding collusion by multiple individuals who each possess a watermarked copy of the data. In addition, it must not be possible to generate a different valid watermark that would implicate a different authorized video stream by combining copies of the same data set.

4. The watermark should still be retrievable if common signal processing operations are applied to the data. These operations include, but are not limited to digital-to-analog and analog-to-digital conversion, resampling, requantization (including dithering and recompression) and common signal enhancements to image contrast and color for example.

5. Retrieval of the watermark should unambiguously identify the original authorized video stream. Moreover, the accuracy of the owner identification should degrade gracefully during attack.

Several previous digital watermarking methods have been proposed. In a first example, an identification string is inserted into a digital audio signal by substituting the “insignificant” bits of randomly selected audio samples with the bits of an identification code. Bits are deemed “insignificant” if their alteration is inaudible. Such a system is also appropriate for two dimensional data such as images. However, this method may easily be circumvented. For example, if it is known that the algorithm only affects the least significant two bits of a word, then it is possible to randomly flip all such bits, thereby destroying any existing identification code.

Alternatively, it has been suggested that a watermark may be inserted into the least significant bits of pixels located in the vicinity of image contours. Since this method relies on modifications of the least significant bits, the watermark is easily destroyed. Further, the method is only applicable to images in that it seeks to insert the watermark into image regions that lie on the edge of contours.

In another example, tags, comprising small geometric patterns-to-digitized images at brightness levels that are imperceptible are added to the video signal. While the idea of hiding a spatial watermark in an image is fundamentally sound, this scheme is susceptible to attack by filtering and redigitization. The fainter such watermarks are, the more susceptible they are to such attacks and geometric shapes provide only a limited alphabet with which to encode information. Moreover, the scheme may not be robust to common geometric distortions, especially cropping.

It has also been suggested that digital watermarks be coded by: vertically shifting text lines, horizontally shifting words, or altering text features such as the vertical endlines of individual characters. Unfortunately, all three proposals are easily defeated and are restricted exclusively to images containing text.

In another example, it has been suggested that watermarks that resemble quantization noise be embedded in the video signal. This idea hinges on the notion that quantization noise is typically imperceptible to viewers. In a first scheme, a watermark is embedded in an image by using a predetermined data stream to guide level selection in a predictive quantizer. The data stream is chosen so that the resulting watermark looks like quantization noise. In a variation of this scheme, a watermark in the form of a dithering matrix is used to dither an image in a certain way. There are several drawbacks to these schemes. The most important is that they are susceptible to signal processing, especially requantization, and geometric attacks such as cropping. Furthermore, they degrade an image in the same way that predictive coding and dithering can.

In another method, certain runs of data in the run length code used to generate the coded fax image are shortened or lengthened. This method is susceptible to digital-to-analog and analog-to-digital conversions. In particular, randomizing the least significant bit (LSB) of each pixel's intensity will completely alter the resulting run length encoding.

An alternative method applies the same signal transform as JPEG (DCT of 8×8 sub-blocks of an image) and embeds a watermark in the coefficient quantization module. While being compatible with existing transform coders, this scheme is quite susceptible to requantization and filtering and is equivalent to coding the watermark in the least significant bits of the transform coefficients.

A “Patchwork” statistical method has been proposed that randomly chooses n pairs of image points (aᵢ, bᵢ) and increases the brightness at aᵢ by one unit while correspondingly decreasing the brightness of bᵢ. The expected value of the sum of the differences of the n pairs of points is claimed to be 2n, provided certain statistical properties of the image are true. In particular, it is assumed that all brightness levels are equally likely, that is, intensities are uniformly distributed. However, in practice, this is very uncommon. Moreover, the scheme may not be robust to randomly jittering the intensity levels by a single unit, and be extremely sensitive to geometric affine transformations.

In a second statistical method called “texture block coding”, a region of random texture pattern found in the image is copied to an area of the image with similar texture. Autocorrelation is then used to recover each texture region. The most significant problem with this technique is that it is only appropriate for images that possess large areas of random texture. The technique could not be used on images of text, for example. Nor is there a direct analog for audio.

Although not directly concerned with watermarking images, U.S. Pat. No. 4,939,515 describes a technique for embedding digital information in an analog signal for the purpose of inserting digital data into an analog TV signal. The analog signal is quantized into one of two disjoint ranges which are selected based on the binary digit to be transmitted. This method is equivalent to watermark schemes that encode information into the least significant bits of the data or its transform coefficients. The '515 patent acknowledges that the method is susceptible to noise and therefore proposes an alternative scheme wherein a 2×1 Hadamard transform of the digitized analog signal is taken. The differential coefficient of the Hadamard transform is offset by 0 or 1 unit prior to computing the inverse transform. This corresponds to encoding the watermark into the least significant bit of the differential coefficient of the Hadamard transform. It is not clear that this approach would demonstrate enhanced resilience to noise. Furthermore, like all such least significant bit schemes, an attacker can eliminate the watermark by randomization.

U.S. Pat. No. 5,010,405 describes a method of interleaving a standard NTSC signal within an enhanced definition television (EDTV) signal. This is accomplished by analyzing the frequency spectrum of the EDTV signal and decomposing it into three sub-bands (L, M, H for low, medium and high frequency respectively). In contrast, the NTSC signal is decomposed into two sub-bands, L and M. The coefficients, Mₖ, within the M band are quantized into M levels and the high frequency coefficients, Hₖ, of the EDTV signal are scaled such that the addition of the Hₖ signal plus any noise present in the system is less than the minimum separation between quantization levels. Once more, the method relies on modifying least significant bits. Presumably, the mid-range rather than low frequencies were chosen because they are less perceptually significant. In contrast, the method proposed in the present invention modifies the most perceptually significant components of the signal.

In another example, small random quantities are added or subtracted from each pixel based on comparing a binary mask of N bits with the least significant bit (LSB) of each pixel. If the LSB is equal to the corresponding mask bit, then the random quantity is added, otherwise it is subtracted. The watermark is extracted by first computing the difference between the original and watermarked images and then by examining the sign of the difference, pixel by pixel, to determine if it corresponds to the original sequence of additions/subtractions. This technique is not based on direct modifications of the image spectrum and does not make use of perceptual relevance. While the technique appears to be robust, it may be susceptible to constant brightness offsets and to attacks based on exploiting the high degree of local correlation present in an image. For example, randomly switching the position of similar pixels within a local neighborhood may significantly degrade the watermark without damaging the image.

U.S. Pat. No. 6,208,735, discloses decomposing the incoming video stream, then distorting or tampering with its components to place the watermark. The video stream is then recomposed from the distorted or tampered components. Decomposition and reconstitution of the images in real time is slow and not appropriate for real time streaming video. This method does not specify the use of chroma components to hide watermark content. Nor does the disclosure specify, directly or by reference, a method of defeating a collusion attack.

In summary, prior art digital watermarking techniques are not robust, and the watermark is easy to remove or difficult to apply in real time. In addition, many prior techniques would not survive common signal and geometric distortions.

### SUMMARY OF THE INVENTION

Briefly stated, the invention in a preferred form is a method and apparatus for digitally fingerprinting authorized video signals. To fingerprint the video signal, a random number generator produces signals having spatial frequencies. The signals thus produced are added to either the chroma data or the intensity data of the authorized video signal using components of a rotating complex exponential. The signals embedded in the authorized video allow identification of the original source of the authorized video signal and thereby enable criminal prosecution of parties responsible for unauthorized duplication of the video signal.

Operation of the random number generator is controlled by a key that is unique to the authorized video signal and by a time code which is representative of the elapsed run time of the video signal. The random number generator derives binary information from the video signal for keying the spatial frequencies of the signal on and off.

When the signals are added to the chroma data of the authorized video signal, such signals are added to perceptually significant chroma data at low intensity. The modified chroma data may then be preserved by common compression algorithms.

The fingerprint or watermark signals are recovered from a suspected video signal by subtracting either the chroma data or the intensity data of the suspected video signal, depending on where the signal has been inserted, from the chroma data or intensity data of the authorized video signal. If the suspected video signal has been transformed, the authorized video signal may be transformed by the same algorithms to facilitate recovery of the fingerprint signals. The presence or absence of spectral components of the recovered fingerprint signal may be detected by either phase coherent demodulation or phase incoherent demodulation at the selected spatial frequencies. The recovered fingerprint signals may be accumulated from frame-to-frame of the video signal.

It is an object of the invention to provide a fingerprint or watermark for digital video data which is substantially perceptually invisible and which may not be removed from the digital video data without rendering such digital video data substantially useless.

It is also an object of the invention to provide a fingerprint or watermark for digital video data which is robust against alteration or misidentification of the source of the authorized video by combination of multiple authorized copies of the video.

It is further an object of the invention to provide a fingerprint or watermark which is easily retrievable from video signals which have undergone common signal processing operations.

Other objects and advantages of the invention will become apparent from the drawings and specification.

### BRIEF DESCRIPTION OF THE DRAWINGS

The present invention may be better understood and its numerous objects and advantages will become apparent to those skilled in the art by reference to the accompanying drawings in which:

FIG. 1 is a schematic flow diagram of a method and apparatus in accordance with the invention for digitally imprinting a fingerprint in a video signal; and

FIG. 2 is a schematic flow diagram of a method and apparatus in accordance with the invention for detecting and recovering a fingerprint in a video signal.

### DETAILED DESCRIPTION OF THE PREFERRED EMBODIMENT

“Fingerprint” or identifying information can be applied to an image by adding complex exponential or sinusoidal signals to the chroma or intensity information in each frame. Chroma data consists of two channels for each pixel, intensity consists of one channel for each pixel. The identifying information can then be recovered by a suitable detection algorithm and used to trace the origin of pirated video data.

Each pixel in the frame is represented by a triple consisting of a red, green, and blue component. This triple is linearly related to intensity, Y, and 2 chroma components. The traditional decomposition for the art world is into intensity, hue, and saturation. For the technical world, the most commonly used decomposition is the “YUV” decomposition. The channel designated “Y” is the intensity, and the U and V components contain the color information. For the subject invention, two arbitrary chroma components are used. The components can be called U′ and V′. The fingerprinting method adds small increments to U′ and V′. These increments are recovered when the fingerprint is read. They can then interpreted as the real and imaginary parts of a two-dimensional complex exponential signal. The components U′ and V′ can be constructed to promote fingerprint hiding, transfer of the fingerprint through any number of transformations and compressions, and computational efficiency.

Because U′ and V′ are orthogonal, the increments can be recovered as the fingerprint is “read”. There is no “crosstalk” between the two increments. Thus, each pixel can be used to deliver two small increments without changing the intensity of the pixel.

For each pixel, the transformation

$$[ \begin{matrix}y \\ {u}^{′} \\ {v}^{′}\end{matrix} ] = T [ \begin{matrix}r \\ g \\ b\end{matrix} ] \qquad ( 1 )$$

can be computed, where T is an orthogonal transformation matrix. The transformation, T can be constructed for any of several purposes, computational efficiency, transfer of data through image data compression algorithms, and so forth. The increments

u″=u′+c (2)

v″=v′+d (3)

can then be added and inverted via the transformation

$$[ \begin{matrix}{r}^{′} \\ {g}^{′} \\ {b}^{′}\end{matrix} ] = T [ \begin{matrix}y \\ {u}^{″} \\ {v}^{″}\end{matrix} ] \qquad ( 4 )$$

The pixel [r′g′b′] would then be transmitted instead of the original [r g b] as part of the fingerprinted image. The pixel transformations on the original data may be deleted because all the operations are linear. The watermark can thus be applied simply via

$$[ \begin{matrix}{r}^{′} \\ {g}^{′} \\ {b}^{′}\end{matrix} ] = T [ \begin{matrix}0 \\ c \\ d\end{matrix} ] + [ \begin{matrix}r \\ g \\ b\end{matrix} ] \qquad ( 5 )$$

The frames corresponding to T [0 c d]^{T} can be precomputed and repeatedly painted over the frames in real time. This enhances the computational efficiency of the algorithm and lends the algorithm to real-time video streaming applications. In a preferred method, the image is changed only at perceptually significant intervals, perhaps only once per second. In addition, the watermark images can be faded into one another to avoid abrupt changes. The watermark is changed slowly compared to human perception so the method will be resistant to frame-swapping attacks. In such an attack, nearly adjacent frames are swapped. This destroys any temporal agreement between the watermark-writing algorithm and the watermark-reading algorithm. When the watermarks persist, the attacker is forced to swap frames that are very distant in time if he wishes to swap frames with different watermarks. If the attacker does this, the content will show a perceptible jerk, and the value of the video will be diminished.

The watermarks are changed by fading to diminish the possibility of reading a watermark by comparing adjacent frames. To get two frames with different watermarks, distant frames must be compared, and it is presumed that the content of the frames will be different enough to obscure the differences in the watermarks.

To read the fingerprint, at each pixel, the increments c and d must be recovered via the subtraction

$$[ \begin{matrix}{r}^{″} \\ {g}^{″} \\ {b}^{″}\end{matrix} ] = [ \begin{matrix}{r}^{′} \\ {g}^{′} \\ {b}^{′}\end{matrix} ] - [ \begin{matrix}r \\ g \\ b\end{matrix} ] \qquad ( 6 )$$

and the inverse transformation

$$[ \begin{matrix}0 \\ c \\ d\end{matrix} ] = {T}^{- 1} [ \begin{matrix}{r}^{″} \\ {g}^{″} \\ {b}^{″}\end{matrix} ] \qquad ( 7 )$$

This holds because of the linearity of the transformation, T. Note that equation (6) cannot be realized without access to the original pixel data, [r g b]^{T}. The original image thus functions as the key in the recovery of the fingerprint data.

In a preferred method, transformation matrix

$${T}^{- 1} = [ \begin{matrix}010 \\ 100 \\ 001\end{matrix} ] \qquad ( 8 )$$

can be used. This uses only the red and blue channels. The green channel is deliberately left unchanged because it is the most easily perceived. By using only the red and blue channels, the least perceptible change is produced for the largest actual fingerprint amplitude. In addition, the transformation is computationally trivial, leading to greater speed of implementation. Two independent increments can thus be applied to each pixel and recovered.

The pixel at location (x, y) has the increments c_{x, y} and d_{x, y}, which can be combined to comprise a single complex value z_{x, y}=c_{x, y}+i d_{x, y}, where i is the square root of (−1). A number of complex exponentials can then be superimposed as follows:

$${z}_{x , y} = {\sum }_{k = 0}^{{k}_{max}} {m}_{k} {ⅇ}^{ⅈ ( {α}_{k} x + {β}_{k} y + s )} \qquad ( 9 )$$

where αₖ and βₖ are angular frequencies in the horizontal and vertical directions, respectively, s is a random shift, and mₖ is the magnitude at each complex frequency.

Binary data is encoded via mₖ. The parameter mₖ is either 0 or M, M being a constant level. Frequency shift keying is used. This means that, for each pair of components, k and k′, if mₖ=0, then, for the matching k′, m_{k′}=M. For kₘₐₓ complex exponentials, kₘₐₓ/2 bits of data can be encoded. The spatial frequencies αₖ and βₖ can be positive or negative, but must fulfill the requirements

αₖ=2πpₖ/xₘₐₓ (10)

and

βₖ=2πqₖ/yₘₐₓ (11)

where pₖ and qₖ and are some positive or negative integers.

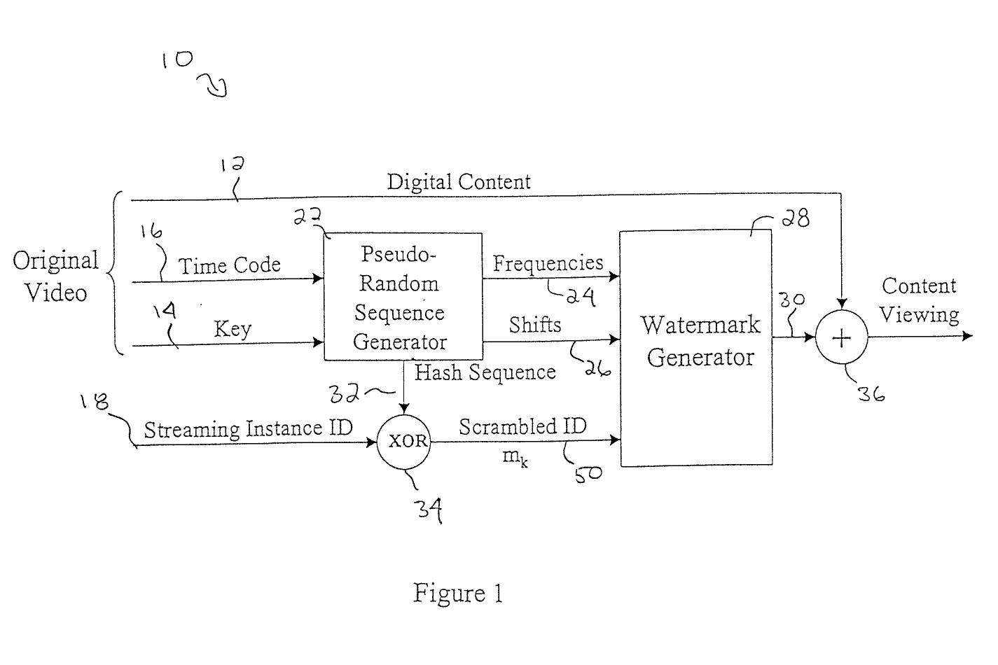

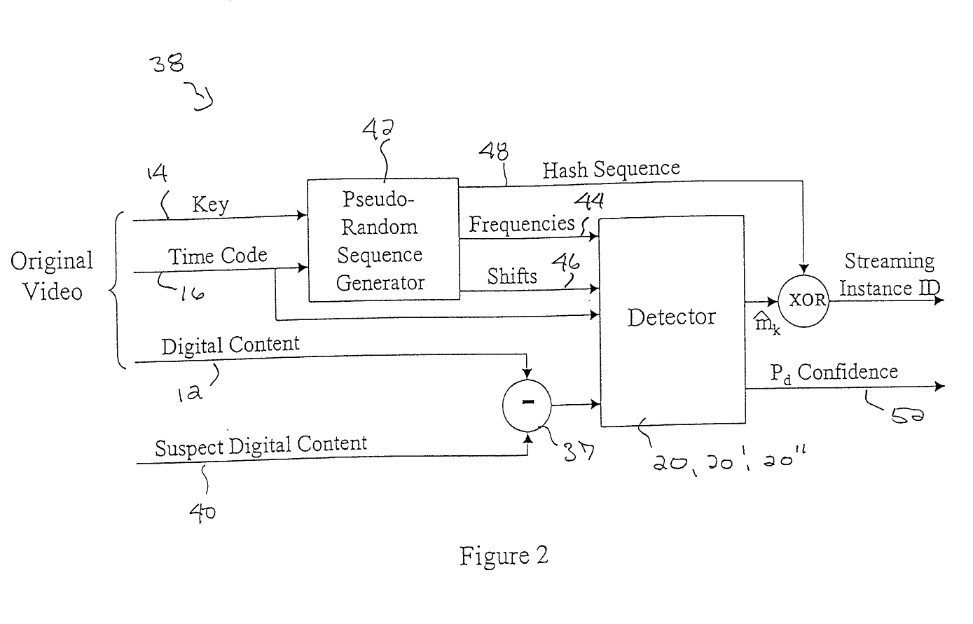

With reference to FIG. 1, the subject method of imprinting a fingerprint 10 in a video signal or streaming video requires the original video stream 12, a key 14, a time code 16, and a video delivery ID 18. The key 14 should be the same for all downloads of a given video stream. The time code 16 is simply a representation of the elapsed run time in the video 12. The video delivery ID 18 is the information that will be recovered by the detector 20 (FIG. 2). The pseudo-random sequence generator 22 computes sets of frequencies 24 and shifts 26, which are used to generate 28 the watermark 30 or fingerprint. It also supplies a hash sequence 32, which is used to scramble 34 the video delivery ID 18. The watermark 30 is applied 36 to the streaming video 12 by addition. It should be appreciated that the watermark generation 28 and pseudo random sequence generation 22 occur at a very slow rate because a new watermark 30 has to be computed only at perceptually significant time intervals, on the order of once a second. The algorithm is thus quite efficient.

The parameters mₖ can be recovered by any one of a variety of realizations of coherent or incoherent detectors 20. A coherent detector 20′ performs the summation

$${\hat{m}}_{k} = \frac{1}{{x}_{max} {y}_{max}} {\sum }_{x = 0}^{{x}_{max} - 1} {\sum }_{y = 0}^{{y}_{max} - 1} {\hat{z}}_{x , y} {ⅇ}^{- ⅈ ( {α}_{k} x + {β}_{k} y + s )} \qquad ( 12 )$$

for all k to provide estimates, \hat{m}ₖ, of the binary levels mₖ used in Equation (9). The input, \hat{z}_{x,y}, is the estimate of the watermark 30 formed by subtracting 37 the suspect frame from the matching frame in the original, non-watermarked, video 12.

An incoherent detector 20″ can be used if it is suspected that the watermark signals are translated spatially. This can happen if the image is compressed using a motion compensator. Motion compensators exploit the fact that portions of the image will be translated in an organized manner as the result of motion in the scene being recorded. When motion compensators are used, portions of a frame will be copied into subsequent frames in appropriate locations. This way, redundant portions of the frames don't have to be encoded repeatedly for each frame, and data compression is improved. However, this can be disruptive when a watermark 30 is applied to a frame. When a portion of the frame is copied to a subsequent frame in a different location, its watermark 30 will also be displaced. The compressor may not accurately duplicate the watermark 30 properly in the subsequent frames, but instead, exhibit a watermark 30 that is broken up and translated. The watermark 30 can still be recovered, with a somewhat lower reliability, by an incoherent detector. An incoherent detector 20″ performs the summation

$${\hat{m}}_{k} = \frac{1}{{x}_{max} {y}_{max}} {\sum }_{n} \vert {\sum }_{( x , y ) ∈ {A}_{n}} {\hat{z}}_{x , h} {ⅇ}^{- ⅈ ( {α}_{k} x + {β}_{k} y + s )} \vert \qquad ( 13 )$$

where the areas of summation, A_{n,} are somewhat arbitrary.

The intensity-based version of watermarking is similar, but it replaces complex exponential watermark signals with real-valued sinusoidal watermark signals, and applies equal signals to the red, green, and blue channels. Therefore, the watermarks 30 are

$${z}_{x , y} = {\sum }_{k = 0}^{{k}_{max}} {m}_{k} cos ( {α}_{k} x + {β}_{k} y + s ) \qquad ( 14 )$$

This signal is applied in combination to the red, green, and blue channels. That is,

$$[ \begin{matrix}{r}_{x , y} \\ {g}_{x , y} \\ {b}_{x , y}\end{matrix} ] = y {z}_{x , y} , \qquad ( 15 )$$

where the vector y is arbitrary. The binary message can be recovered by a coherent detector as

$${\hat{m}}_{k} = \frac{2}{{x}_{max} {y}_{max}} {\sum }_{x = 0}^{{x}_{max} - 1} {\sum }_{y = 0}^{{y}_{max} - 1} {\hat{z}}_{x , y} {ⅇ}^{- ( {α}_{k} x + {β}_{k} y + s )} \qquad ( 16 )$$

or by an incoherent detector 20″ as

$${\hat{m}}_{k} = \frac{2}{{x}_{max} {y}_{max}} {\sum }_{n} \vert {\sum }_{( x , y ) ∈ {A}_{n}} {\hat{z}}_{x , h} {ⅇ}^{- ( {α}_{k} x + {β}_{k} y + s )} \vert \qquad ( 17 )$$

In equations (15) and (16), \hat{z}_{x,y} is a weighted average of the red, green, and blue channel errors:

\hat{z}_{x,y}=y₁(\tilde{r}_{x,y}−r_{x,y})+y₂(\tilde{g}_{k,y}−g_{x,y})+y₃(\tilde{b}_{x,y}−b_{x,y}) (18)

where r, g, and b refer to the color channels, and the tilde distinguishes the suspect video from the original video 12, which has no tilde. The coefficients y₁, y₂, and y₃ are the elements of the vector y in equation (15).

With reference to FIG. 2, in the subject method for detecting and recovering a fingerprint 38 in a video signal, the suspect video 40 is compared to the original video 12. The “original” video 12 may, in fact, be processed to more closely resemble the suspect video 40. It can be compressed, decompressed, or otherwise transformed to mimic the history of the suspect video 40. The pseudo random sequence generator 42 is a duplicate of that in FIG. 1. It produces the same frequencies 44, shifts 46, and hash sequences 48 in response to the same key 14 and time code 16. The detector 20 extracts estimates, \hat{m}ₖ, of the parameters mₖ comprising the scrambled video delivery ID 50 via equations (12), (13), (16) and/or (17).

The detector 20 outputs, \hat{m}ₖ, can be added from frame to frame to improve the signal-to-noise ratio of the detection algorithm. The advantage of using a sinusoidal or rotating complex exponential signal is that if the fingerprint 30 is shifted spatially (by a motion compensating algorithm, for example) it can still be recovered by an incoherent detector 20″.

The frequencies pₖ and qₖ are selected so that the fingerprint 30 and typical chroma data occupy the same spectral area, producing two outcomes. First, any good image compression algorithm will retain the fingerprint data, because it must, by design, retain the chroma data in the original image. Second, it will tend to hide the fingerprint 30 and make it difficult or impossible to detect and erase.

If a black-and-white property is fingerprinted 10, the option of using chroma data is still available, as long the three color channels are available. In this case, however, an attacker might immediately identify any chroma content as a watermark 30, and could remove it via trivial operations. The attacker would only have to force the red, green, and blue channels to be equal at each pixel. This would zero the color information. If the watermark 30 is missing, then tampering would be evident. However, the guilty party couldn't be identified, and this is one of the objectives of the present methodology.

Numerical experiments have shown that, even if the fingerprinted image is compressed or otherwise corrupted, the inversion of equations (5) and (6) can still be performed with sufficient accuracy to recover the identifying information.

The fingerprinting method should be made resistant to transformations common to digital movie processing, such as compression, transfer to video tape, scaling, and cropping. The fingerprinting method should also be resistant to deliberate attacks. The current method is intended to be resistant to overwriting attacks, and to frame-shifting attacks. Sufficient capacity should be available to enable defeat of collusion attacks using the methods outlined by Boneh and Shaw in “Collusion-secure Fingerprinting for Digital Data”, Crypto '95, LNCS 963, Springer-Verlag, Berlin 1995, pp. 452-465, and subsequent methods. The fingerprinting method should be constructed in such a way that detection of the fingerprint 30 on a single frame or sequence of frames gives the attacker little information on the specifics of the fingerprint 30 in other frames.

To make the subject method resistant to overwriting, a spread-spectrum concept is employed. The frequencies pₖ and qₖ are selected at random from a larger set than necessary. This leaves a lot of “silent” bandwidth in the fingerprint spectrum. If an attacker wishes to cover up the fingerprint 30, he must cover up the entire available spectrum, and, if the frequencies are chosen properly, such an attack will seriously degrade the image quality before it obscures the fingerprint 30.

With complex-valued color watermarks 30, positive and negative frequencies in the horizontal and vertical dimensions are used. Through experimentation, it was found that discrete frequencies up to 16 would be duplicated satisfactorily by most commonly-used video compressors operating at moderate fidelity down into the 240 by 162 pixel range. At higher fidelity, of course, more bandwidth will be available for watermarks. This provides at least 256 (=16²) frequencies in each quadrant of the frequency plane and 1024 (=4·256) frequencies from which to choose. Because an FSK method is used, each bit of data is detected by computing the fingerprint amplitude at two frequencies. The levels at the two frequencies are compared, and the outcome identifies the bit value. In essence, the extra frequency is used to establish a background noise level. In the current realization, frequencies in the β>0 half-plane are taken to mean “1”. The amplitude at frequency (αⱼ, βₖ) (=A(αⱼ, βₖ)) is compared to the amplitude A(αⱼ, βₖ₊₁), with k odd. The phases of the complex exponentials are determined at random. This tends to defeat overwriting attacks. When intensity-based watermarks 30 are used, only positive frequencies are available. Because compressors allocate more bandwidth to intensity information, more bandwidth is available for the spread spectrum method when intensity-based watermarking is performed.

To ensure that the information is spread sufficiently to deter or defeat an overwrite attack, the number of available frequencies can be increased beyond 1024, and less than 32 bits can be allocated to each frame.

The overall method requires a 64-bit key 14, which must be kept secret from the users. During the analysis of the pirated copy, the analyst must know the key 14 without guessing. Therefore, the key 14 needs to be managed and controlled. In the current design, 32 bits have been encoded in a frame. This number can be revised upward if necessary, and to defeat a collusion attack, it will almost certainly be revised up a great deal. Many different 32-bit messages can be encoded during a full-length video. Numerical experiments have shown that it is reasonable to expect a data rate on the order of 2 bits per second can be achieved.

The fingerprint 30 is generated by first computing a stream of random numbers recursively using the 64-bit private key 14. The initial value in the recursion is a 64-bit number derived from the time code 16 for the elapsed time in the video 12. This number should be changed at roughly one-second intervals. It can be the number of seconds since the beginning of the video 12. This is important to deter a frame-swapping attack. This stream of random bits is used to do two things. It is used to select the frequencies actually used from the 1024 available frequencies. It is also used to scramble (“x-or”) 34 the 32 bit source identity. Of course, the bit stream is duplicated exactly during the analysis of the watermarked video because the same pseudo-random processes are duplicated.

This method successfully defeats attacks. First, even if the attacker can “read” the pattern in a given frame, and even if he knows the 32-bit streaming instance ID 18, the attacker can make no inferences about the pattern in any other frames. To erase the fingerprints 30 in every frame, the attacker has to detect the fingerprints 30 independently in each frame. A frame-swapping attack consists of swapping adjacent or nearly-adjacent frames so the person analyzing the pirated copy won't have a reliable time reference. By repeating the pattern for a full second, the attacker is forced to swap frames that are temporally very far apart. Such swapping will seriously degrade the video. In addition, during analysis, adjacent time-increments can be searched, so the attacker may have to swap frames at several seconds apart. If this is done for an entire video, its viewing value will be worthless.

Fingerprinting may have to be disabled for certain frames because of their content. For example, if a segment of the video is in black and white, a chroma-based fingerprint will be easily detectable because the red, green, and blue channels will have unequal pixel values. Also, a pure black frame, or, for that matter, any frame with exactly uniform color will easily reveal a chroma-based or intensity-based watermark.

To evaluate the performance of the system, the probability of detection (P_{d}) 52 was computed, defined by

$${P}_{d} = {\prod }_{i = 1}^{{N}_{bits}} erf ( \frac{\vert {\hat{m}}_{i} - {\hat{m}}_{{i}^{′}} \vert}{{σ}_{i}} ) \qquad ( 19 )$$

where N_{bits} is the number of bits in the message, \hat{m}ᵢ and \hat{m}ᵢ, are the estimated bit values at the two frequencies (0 and 1) corresponding to the i^{th} bit, σᵢ, is the noise standard deviation at the i^{th} bit, and erf( ) is the error function

$$erf ( x ) = \frac{1}{\sqrt{2 π}} {\int }_{- ∞}^{x} {ⅇ}^{\frac{- {y}^{2}}{2}} ⅆ y \qquad ( 20 )$$

This is the probability that the entire 32-bit message was received correctly. A 19-second segment of video digitized at 10 frames per second and 192 by 144 pixels per frame was watermarked with both the chroma-based and intensity-based scheme. The amplitude of the watermark 30 was varied. The watermarked videos were compressed to either 100 Kbits/second or 56 Kbits/second, the watermarks 30 were read, and the probability of detection, defined by equation (19), was computed. Compression was performed using the MPEG-4 version 2 algorithm incorporated into Adobe Premiere™. Two different versions of the “original video” 12 were subtracted to isolate the watermark 30. One version was compressed to roughly 200 Kbits/second using the MPEG-4 version 2 algorithm incorporated into Microsoft DirectX GraphEdit™. This pre-compressed original is used because it is expected to more closely match the compressed video containing the watermark 30. The exact compression isn't duplicated because this could create an unfair test. The “Amplitude” listed is the zero-to-peak amplitude of each sinusoid or complex exponential in the watermark. The detector outputs were accumulated over time. The probabilities of detection were computed after accumulating 89 and 189 frames.

Testing has demonstrated that the watermarks 30 may be somewhat visible at an amplitude of 1.0 but are practically invisible at an amplitude of 0.4. The results confirm that the watermarks 30 are recoverable even after compression to 56 Kbits/second at an amplitude of 0.4, at which time the watermarks are invisible. Tables 1-8 provide a summary of the test results.

TABLE 1
Intensity-Based Watermark, Template MPEG
Compressed by DirectX, 100 Kbit/sec Compressed Watermark

| Amplitude | P_{d} Frame 89 | P_{d} Frame 189 |
|---|---|---|
| 1.0 | 1.000000 | 1.000000 |
| 0.4 | 0.971192 | 0.999874 |
| 0.2 | 0.093988 | 0.658279 |
| 0.1 | 0.004879 | 0.103871 |

TABLE 2
Intensity-Based Watermark, Template
Uncompensated,
100 Kbit/sec Compressed Watermark

| Amplitude | P_{d} Frame 89 | P_{d} Frame 189 |
|---|---|---|
| 1.0 | 1.000000 | 1.000000 |
| 0.4 | 0.951268 | 0.999878 |
| 0.2 | 0.081152 | 0.664891 |
| 0.1 | 0.006514 | 0.105802 |

TABLE 3
Color-Based Watermark, Template MPEG
Compressed by DirectX, 100 Kbit/sec Compressed Watermark

| Amplitude | P_{d} Frame 89 | P_{d} Frame 189 |
|---|---|---|
| 1.0 | 1.000000 | 1.000000 |
| 0.4 | 0.130003 | 0.458904 |
| 0.2 | 0.009752 | 0.029662 |
| 0.1 | 0.003339 | 0.118898 |

TABLE 4
Color-Based Watermark, Template Uncompensated,
100 Kbit/sec Compressed Watermark

| Amplitude | P_{d} Frame 89 | P_{d} Frame 189 |
|---|---|---|
| 1.0 | 1.000000 | 1.000000 |
| 0.4 | 0.592121 | 0.980981 |
| 0.2 | 0.018671 | 0.120338 |
| 0.1 | 0.004132 | 0.017812 |

TABLE 5
Intensity-Based Watermark, Template MPEG
Compressed by DirectX, 56 Kbit/sec Compressed Watermark

| Amplitude | P_{d} Frame 89 | P_{d} Frame 189 |
|---|---|---|
| 1.0 | 1.000000 | 1.000000 |
| 0.4 | 0.699279 | 0.989730 |
| 0.2 | 0.000021 | 0.007408 |
| 0.1 | 0.000256 | 0.031345 |

TABLE 6
Intensity-Based Watermark, Template
Uncompensated,
56 Kbit/sec Compressed Watermark

| Amplitude | P_{d} Frame 89 | P_{d} Frame 189 |
|---|---|---|
| 1.0 | 0.971840 | 0.999713 |
| 0.4 | 0.072495 | 0.865681 |
| 0.2 | 0.006180 | 0.188356 |
| 0.1 | 0.000428 | 0.031930 |

TABLE 7
Color-Based Watermark, Template MPEG
Compressed by DirectX, 56 Kbit/sec Compressed Watermark

| Amplitude | P_{d} Frame 89 | P_{d} Frame 189 |
|---|---|---|
| 1.0 | 0.989450 | 1.000000 |
| 0.4 | 0.984860 | 1.000000 |
| 0.2 | 0.002788 | 0.017475 |
| 0.1 | 0.002175 | 0.012230 |

TABLE 8
Color-Based Watermark, Template Uncompensated,
56 Kbit/sec Compressed Watermark

| Amplitude | P_{d} Frame 89 | P_{d} Frame 189 |
|---|---|---|
| 1.0 | 0.998696 | 1.000000 |
| 0.4 | 0.997572 | 1.000000 |
| 0.2 | 0.018671 | 0.008065 |
| 0.1 | 0.003230 | 0.002867 |

What is claimed is:

1. A method of digitally fingerprinting authorized video signals comprising the steps of:
producing signals with spatial frequencies selected by a crypto graphically secure random number generator; and
adding the signals to the chroma data of the video signal using components of a rotating complex exponential;
whereby the signals identify the original source of the authorized video signal and thereby enable criminal prosecution of parties responsible for unauthorized duplication of the video signal.

2. The method of claim 1 further comprising the step of controlling the random number generator with a key that is unique to the video signal to be watermarked.

3. The method of claim 1 further comprising the step of inputting a time code representative of the elapsed time of the video signal into the random number generator.

4. The method of claim 1 further comprising the step of crypto graphically deriving binary information from the video signal for keying the spatial frequencies on and off.

5. The method of claim 1 wherein the signals are added by perceptually significant chroma data at low intensity.

6. The method of claim 1 wherein the signals are added by chroma data and the method further comprises the step of preserving the chroma data by common compression algorithms.

7. The method of claim 1 further comprising the step of recovering the signals by subtracting the chroma data of a suspected unauthorized copy of the video signal from the chroma data of the authorized video signal.

8. The method of claim 7 further comprising the step of transforming the authorized video signal.

9. The method of claim 8 wherein the authorized video signal is transformed by the same algorithm or algorithms as the suspected unauthorized copy of the video signal.

10. The method of claim 7 further comprising the step of accumulating recovered signals from frame to frame.

11. The method of claim 7 further comprising the step of detecting the presence or absence of spectral components in the recovered signals by phase coherent demodulation at the selected spatial frequencies.

12. The method of claim 11 further comprising the step of accumulating recovered signals from frame to frame.

13. The method of claim 12 further comprising the step of interpreting the presence or absence of spectral components in the recovered signals to identify the authorized video signals from which the suspected unauthorized copy of the video signal was created.

14. The method of claim 13 wherein the step of interpreting provides a high probability of identifying any unauthorized copies of the authorized video signal and a negligible probability of identifying an authorized video signal which was not copied.

15. The method of claim 7 further comprising the step of detecting the presence or absence of spectral components in the recovered signals by phase incoherent demodulation at the selected spatial frequencies.

16. The method of claim 15 further comprising the step of accumulating recovered signals from frame to frame.

17. The method of claim 16 further comprising the step of interpreting the presence or absence of spectral components in the recovered signals to identify the authorized video signals from which the suspected unauthorized copy of the video signal was created.

18. The method of claim 17 wherein the step of interpreting provides a high probability of identifying any unauthorized copies of the authorized video signal and a negligible probability of identifying an authorized video signal which was not copied.

19. The method of claim 7 further comprising the step of detecting the presence or absence of spectral components in the recovered signals by phase incoherent demodulation at the selected spatial frequencies.

20. The method of claim 9 further comprising the step of detecting the presence or absence of spectral components in the recovered signals by phase incoherent demodulation at the selected spatial frequencies.

21. A method of digitally fingerprinting authorized video signals comprising the steps of:
producing signals with spatial frequencies selected by a crypto graphically secure random number generator; and
adding the signals to the intensity data of the video signal using components of a rotating complex exponential;
whereby the signals identify the original source of the authorized video signal and thereby enable criminal prosecution of parties responsible for unauthorized duplication of the video signal.

22. The method of claim 21 further comprising the step of recovering the signals by subtracting the intensity data of a suspected unauthorized copy of the video signal from the intensity data of the authorized video signal.

23. A method of digitally fingerprinting authorized video signals comprising the steps of:
deriving a unique key from the authorized video signal;
inputting the key into a crypto graphically secure random number generator;
controlling the random number generator with the key to produce signals with spatial frequencies; and
adding the signals to a portion of the authorized video signal using components of a rotating complex exponential;
whereby the signals identify the original source of the authorized video signal and thereby enable criminal prosecution of parties responsible for unauthorized duplication of the video signal.
